(19) United States
(12) Patent Application Publication
(10) Pub. No.: US 2022/0251421 A1
(43) Pub. Date: Aug. 11, 2022

(54) SEED COATINGS COMPOSITIONS AND METHODS FOR USE

(71) Applicant: RHODIA OPERATIONS, Aubervilliers (FR)

(72) Inventors: Jean-Christophe CASTAING, Sèvres (FR); Clara VERNAY, Paris (FR)

(21) Appl. No.: 17/627,714

(22) PCT Filed: Jul. 23, 2020
(86) PCT No.: PCT/EP2020/070806

§ 371 Date: Jan. 17, 2022

(30) Foreign Application Priority Data
Jul. 23, 2019 (EP) 19187828.9

(51) Int. Cl. C09D 193/04; A01N 25/10; A01N 25/24

(52) U.S. Cl. CPC C09D 193/04; A01N 25/24; A01N 25/10

(57) ABSTRACT

A seed or seedling is coated with a least one rosin-based resin and optionally, a second binder, which is for instance a biodegradable polymer. The seed coating composition is characterized by a dust value, as measured using a Heubach dustmeter device according to Euroseeds reference method “Assessment of free floating dust and abrasion particles of treated seeds as a parameter of the quality of treated seeds”, which is lower by at least 30% as compared to an analogous binder-free composition that does not contain the rosin-based resin.

This application claims priority filed on 23 Jul. 2019 in Europe with Nr 19187828.9, the whole content of this application being incorporated herein by reference for all purposes.

This invention relates to methods and compositions relating to agricultural coatings and, in particular, to seeds coated with rosin-based resins, and methods for use, as well as improved dust suppression effects from using such compositions.

Plant seeds are often coated before sowing, for example to provide useful substances (active ingredients) to the seed and to the seedlings upon germination, for example plant nutrients, growth stimulating agents, and plant protection products.

An important advantage of providing active ingredients in a seed coating is that it allows for a precise and controlled release and dose per seedling.

One of the major challenges today is to increase adherence of the coating composition to the seed surface. Increased adherence to the seed actually results in a reduction of dust-off.

Dusting-off by release of fragments of the coating in the form of dust particles is a problem because it can result in loss of valuable active ingredients and a less precise and less controlled dosing of the active ingredients. In addition, dusting-off of the coating can sometimes form a risk for the environment and for the health of workers handling the coated seed.

It is thus desirable to provide improved coating compositions, and especially to provide compounds that are able to increase adherence of the coating to the seed surface and to decrease dust emissions. It is also desirable to provide compounds that have a favorable toxicological and/or ecological profile and desirable characteristics in terms especially of biodegradability, low toxicity or low hazard level.

It has been found, unexpectedly, that dusting-off could be significantly decreased by using rosin-based resins as described hereunder.

The present invention concerns seed coating compositions that are easy to process and to apply on seed, transport and handle, and in particular possesses dust-suppression benefits.

In one embodiment, the present invention relates to a coated seed composition comprising:

at least one seed; and

at least one layer coating all or part of the seed, the layer comprising at least one rosin-based resin.

Advantageously, the present invention can provide seeds with a lower Heubach dust value (ESA STAT Working group, 2011), for example a reduction of the Heubach dust value of at least 30% compared to an analogous binder-free composition that does not contain the rosin-based resin.

ESTA standard is the standard on quality assurance for seed treatment and treated seed of Euroseeds (non-profit organization representing the interest of the European seeds sector), supported by the Euroseeds membership and the agrochemical industry. To assess dust levels of treated seed the Euroseeds method (standard protocol) “Assessment of free floating dust and abrasion particles of treated seeds as a parameter of the quality of treated seeds” is the reference method. This standard method is based on the Heubach dustmeter measurement.

According to the present invention, the reduction of the Heubach dust value is measured according to Euroseeds reference method “Assessment of free floating dust and abrasion particles of treated seeds as a parameter of the quality of treated seeds”, which is herein incorporated by reference for all purposes.

According to the invention, the impact of using a rosin-based resin as binder on the Heubach dust value is to be measured by comparing on the one hand the Heubach dust value of a binder-free composition that does not contain said rosin-based resin and on the other hand the Heubach dust value of an analogous composition containing said rosin-based resin as sole binder. By “binder-free composition” is meant a composition substantially free from any additional binder.

In another embodiment, the present invention relates to a method for preparing a coated seed composition having dust suppression benefits comprising the step of contacting at least a portion of at least one seed with at least one layer comprising at least one rosin-based resin, wherein the coated seed composition is characterized by a dust value, as measured using a Heubach dustmeter device according to Euroseeds reference method “Assessment of free floating dust and abrasion particles of treated seeds as a parameter of the quality of treated seeds”, which is lower by at least 30% as compared to an analogous binder-free composition that does not contain the rosin-based resin.

In another embodiment, the present invention relates to the use of at least one rosin-based resin as binder for seed coating applications, for instance to provide dust suppression benefits.

In another embodiment, the present invention relates to a seed coating composition comprising at least one rosin-based resin.

The present invention relates to the development of rosin-based resin as novel bio-based (i.e. made from renewable bio-sources) binding material (also referred to as “binder”) for seed treatment applications in agricultural industry. Such material can be easily mixed into seed treatment formulations and used in seed treatment process. As mentioned previously, this binding material reduces the loss of seed treatment formulation ingredients from dust-off. The present invention provides thus a binding material from bio-source that shows good performance in dust-off reduction, seed safety, processability (i.e., ease of processing) and plantability.

It is already know that a seed may be coated for additional various reasons such as to aid in sustaining the seed is adverse conditions, to aid in propagating the seed, to provide a protective layer for the seed, when the seed is too small or non-uniform (from seed to seed) and the shape of sown seeds is desired to be uniform, and the like. In one embodiment, seed coating compositions described herein are prepared such that they are smoother, rounder, more uniform, and optionally, can also be larger and/or heavier than the original seed. Techniques utilized to “sow” the seed can vary from a belt, plate, cup, vacuum or the like. The seed coating composition can be placed individually, with improved spacing and depth control. The seed coating composition described herein can flow better through the seeding mechanism, because their surface is smoother than that of non-coated seed.

Thus, the present invention and its use of bio-based binding material are important to seed treatment industry due mainly to its effects of:
(1) Preventing the loss of active ingredients in the seed coating after treatment,
(2) Reducing the potential negative sequence from unintended deposit of hazardous active ingredients,
(3) Facilitating the seed treatment process and/or
(4) Improving seed plantability and flowability.

Advantageously the rosin-based resins of the invention have a reduced environmental and health impact compared with coatings made from synthetic polymer materials. In particular, the rosin-based resins of the invention are not considered as “polymers” (within the meaning of Article 3(5) of Regulation (EC) No 1907/2006) and thus they do not fall under the regulations set out by the European Chemical Agency (ECHA) regarding restricted use of oxo-plastics and intentionally added microplastic particles.

In one embodiment, a rosin-based resin of the invention does not comprise polymers within the meaning of Article 3(5) of Regulation (EC) No 1907/2006. In other words, a rosin-based resin that would be considered as a polymer within the meaning of Article 3(5) of Regulation (EC) No 1907/2006 would not fall under the scope of the present invention.

In one embodiment, the present invention relates to a method for preparing a coated seed composition having dust suppression benefits comprising the step of contacting at least a portion of at least one seed with at least one layer comprising at least one rosin-based resin which does not comprise polymers within the meaning of Article 3(5) of Regulation (EC) No 1907/2006, wherein the coated seed composition is characterized by a dust value, as measured using a Heubach dustmeter device according to Euroseeds reference method “Assessment of free floating dust and abrasion particles of treated seeds as a parameter of the quality of treated seeds”, which is lower by at least 30% as compared to an analogous binder-free composition that does not contain the rosin-based resin.

In one embodiment, the present invention relates to the use of at least one rosin-based resin which does not comprise polymers within the meaning of Article 3(5) of Regulation (EC) No 1907/2006, as binder for seed coating applications, for instance to provide dust suppression benefits.

Throughout the description, including the claims, the term “comprising one” should be understood as being synonymous with the term “comprising at least one”, unless otherwise specified, and “between” should be understood as being inclusive of the limits.

The term “coating” is meant to refer to applying material to a surface of a seed, for instance as a layer of a material around a seed. Coating includes film coating, pelleting, and encrusting. Pellets obtained with pelleting are also known as seed pills. The coating is preferably applied over substantially the entire surface of the seed, such as over 90% or more of the surface area of the seed, to form a layer. However, the coating may be complete or partial, for instance over 20% or more of the surface area of the seed, or 50% or more.

The term “seed coating composition” is meant to refer to a composition to be used for coating of seed, possibly after combination of the composition with other compositions, such as plant protection products, diluents such as water and/or other active ingredients such as plant nutrients or growth stimulating agents. Hence, the term includes both compositions that do and do not contain plant protection products.

The expression “provide dust suppression benefits” means provide seeds with a lower Heubach dust value (ESA STAT Working group, 2011), for example a reduction of the Heubach dust value (measured according to Euroseeds reference method “Assessment of free floating dust and abrasion particles of treated seeds as a parameter of the quality of treated seeds”) of at least 30% compared to an analogous binder-free composition, for example of at least 40%, or for at least 50%, or for at least 60%, or for at least 70%, or for at least 80%

As used herein, “alkyl” groups include saturated hydrocarbons having one or more carbon atoms, including straight-chain alkyl groups, such as methyl, ethyl, propyl, butyl, pentyl, hexyl, heptyl, octyl, nonyl, decyl, cyclic alkyl groups (or “cycloalkyl” or “alicyclic” or “carbocyclic” groups), such as cyclopropyl, cyclopentyl, cyclohexyl, cycloheptyl, and cyclooctyl, branched-chain alkyl groups, such as isopropyl, tert-butyl, sec-butyl, and isobutyl, and alkyl-substituted alkyl groups, such as alkyl-substituted cycloalkyl groups and cycloalkyl-substituted alkyl groups. In complex structures, the chains may be branched, bridged, or cross-linked.

Should the disclosure of any patents, patent applications, and publications which are incorporated herein by reference conflict with the description of the present application to the extent that it may render a term unclear, the present description shall take precedence.

As mentioned previously, the present invention relates to the use of at least one rosin-based resin as binder in seed coating compositions, and more especially to a coated seed composition comprising at least one seed and at least one layer coating all or part of the seed, the layer comprising at least one rosin-based resin as binder.

According to the invention, the term “rosin-based resin” encompasses any rosin acids, rosin acid derivatives and rosin esters, and mixtures thereof, as defined hereunder.

A “rosin acid” according to the present invention is understood to comprise a mixture of various rosin acid molecules. Mixtures of this kind that are readily available and occur in nature include, but are not limited to, tall oil rosin, gum rosin or wood rosin. Wood rosin is harvested from the stumps of trees. Gum rosin is collected from the sap of trees in regions such as China and Brazil. Tall oil rosin is a by-product of the Kraft paper process. Other possible sources for rosin acid include pitch. Mention may be made for instance of white pitch (pix alba) and burgundica pitch (pix burgundica).

These natural mixtures may comprise rosin acid molecules such as abietic acid, neoabietic acid, palustric acid, levopimaric acid, dehydroabietic acid, pimaric acid, sandaracopimaric acid or isopimaric acid or, among others, in varying amounts. The distribution of rosin acid molecules varies within each of these sources. Rosin acids may be partially or fully hydrogenated or disproportionated.

A “rosin acid derivative” according to the present invention is any molecule that has the molecular rosin acid backbone but is modified in at least one of the following ways. In one embodiment, at least one double bond is hydrogenated (hydrogenation). In another embodiment, at least one of the rings of the rosin and backbone is dehydrogenated so that an aromatic ring results (dehydrogenation). In yet another embodiment, adducts to the conjugated double bonds of the rosin acid backbone are included, in particular the addition of maleic anhydride in a Diels-Alder type reaction. The resulting adduct is considered one type of a rosin acid derivative according to the present invention.

A “rosin ester” according to the present invention is any molecule in which at least two rosin acid or rosin acid derivative units are connected by means of at least two ester linkages. Any molecule with at least two hydroxyl groups can be used to provide the ester linkage between at least two rosin acids units. Common examples include, but are not limited to, glycerol esters, pentaerythritol esters and triethylene glycol esters. Any low molecular weight compounds containing multiple hydroxyl groups could be used to produce rosin esters. The term “rosin ester” also encompasses rosin ester derivatives, namely rosin esters as defined previously that have been further modified in order to fine tune the physicochemical properties (such as the softening point or viscosity) of said rosin ester.

In one embodiment, the reaction product of rosin acid and a monoalcohol (such as methanol) is also encompassed by the term “rosin ester”.

Rosin modified phenolic resins (also referred to as “rosin-phenol-formaldehyde”), which result from the inclusion of rosin components into phenol-formaldehyde prepolymers, are not considered as “rosin-based resins” in the sense of the present invention.

In one embodiment, the binder of the invention comprises at least one rosin-based resin as defined previously.

In one embodiment, the binder of the invention comprises at least one rosin acid, one rosin acid derivative or one rosin ester as defined previously.

The rosin-based resin of the invention may be provided in the form a resin dispersion.

According to one embodiment, the rosin-based resin of the invention is provided in the form a resin dispersion comprising at least said rosin-based resin, at least one surfactant and water. “Resin dispersions” in the sense of the present invention are dispersions of resin entities wherein the solvent is generally water or an aqueous solution. However, mixtures of water with a non-aqueous solvent, in particular an organic solvent, would also be suitable as long as the foaming properties or other dispersion properties are not negatively affected. Mixtures of water with other water-soluble solvents could also be used as well. Any conventional surfactant or combination of surfactants is suitable for use in the resin dispersions of the invention.

In one embodiment, the average particle size of the resins in the resin dispersions as discussed above is suitably less than about 10 μm. For example, the average particle size of the resin is less than about 2 μm.

In one embodiment, the average particle size of the resin is comprised between 500 nm and 2 μm, for instance between 500 nm and 1.5 μm, for instance around 1 μm.
In another embodiment, the average particle size of the resin is less than about 1 μm or even less than about 500 nm. In another embodiment, the average particle size of the resins is less than about 250 nm. Generally, particle sizes and particle size distributions are measured with (laser) light scattering methods.

The solids content, i.e. the dry content of resinous material and surfactants, in the resin dispersion is suitably at least about 20% by weight up to the maximum content achievable such as, for example, at least about 50% to about 70% by weight, for instance to about 65% by weight, relative to the overall weight of the dispersion. In one embodiment, the solids content in the resin dispersion is from about 51% by weight, for instance 52% by weight to about 65% by weight, relative to the overall weight of the dispersion.

In one embodiment, the resin dispersion may be produced by a batch inversion process. In another embodiment, they may be produced using a continuous process. In other embodiments of the present invention, the resin dispersions may be produced by various methods including total solvent systems, solvent-assisted systems, and waterborne systems.

In addition, conventional additives such as plasticizers(s), thickener(s), biocide/preservative(s) and antioxidant(s) may be added to the resin dispersions of the present invention.

Examples of suitable rosin acids include, but are not limited to, Dermulsene A7510 from DRT, Foralyn E from Eastman, Sylvaros DR 731 from Kraton, or Snowtack 765A from Lawter.

Examples of suitable rosin esters include, but are not limited to, Tacolyn 3509 from Eastman, Tacolyin 3100 from Eastman, Tacolyn 3400 from Eastman, Foralyn 90 from Eastman, Dermulsene RE 1513 from DRT, Dermulsene 222 from DRT, Aquatac FC8560 from Kraton, Aquatac XR4343 from Kraton, Aquatac 6085 from Kraton, Aquatac 6025 from Kraton or Snowtack SE724G from Lawter.

In one embodiment, the binder of the invention may further comprise at least one terpene resin or hydrogenated terpene resin.

Terpene resins are defined as resins produced from at least one terpene monomer. For example, α-pinene, β-pinene, d-limonene, and dipentene can be polymerized in the presence of aluminum chloride to provide terpene resins.

According to anyone of the invention embodiment, the rosin-based resin of the invention has a Ring and Ball softening point ranging from about 10° C. to about 150° C., for instance from about 20° C. to about 100° C., for instance from about 25° C. to about 90° C.

According to a preferred embodiment, the rosin-based resin of the invention has a Ring and Ball softening point ranging from about 10° C. to about 65° C., for instance from about 20° C. to about 60° C., for instance from about 30° C. to about 55° C., for instance from about 35° C. to 50° C.

In one embodiment, the present invention relates to a method for preparing a coated seed composition having dust suppression benefits comprising the step of contacting at least a portion of at least one seed with at least one layer comprising at least one rosin-based resin having a Ring and Ball softening point ranging from about 10° C. to about 65° C., for instance from about 20° C. to about 60° C., for instance from about 30° C. to about 55° C., for instance from about 35° C. to 50° C., wherein the coated seed composition is characterized by a dust value, as measured using a Heubach dustmeter device according to Euroseeds reference method “Assessment of free floating dust and abrasion particles of treated seeds as a parameter of the quality of treated seeds”, which is lower by at least 30% as compared to an analogous binder-free composition that does not contain the rosin-based resin.

In one embodiment, the present invention relates to the use of at least one rosin-based resin having a Ring and Ball softening point ranging from about 10° C. to about 65° C., for instance from about 20° C. to about 60° C., for instance from about 30° C. to about 55° C., for instance from about 35° C. to 50° C., as binder for seed coating applications, for instance to provide dust suppression benefits.

According to anyone of the invention embodiment, the rosin-based resin of the invention has a Brookfield viscosity at 20° C., 50 min-1 ranging from about 50 to about 1,000 mPa·s, for instance from about 100 to about 900 mPa·s, for instance from about 125 to about 750 mPa·s.

Warm melt polymers such as those described in US2008/0109922 are not considered as “rosin-based resin” in the sense of the present invention. According to the invention, a rosin-based resin of the invention is different from a polymer containing at least one ester group fabricated from a reaction of a rosin and a hydroxyl-containing water-soluble polymer (such as especially polyethylene glycol or polyoxyethylene polyoxypropylene glycol block copolymer).

In a further embodiment, the composition of the present invention is characterized by a dust value, as measured using a Heubach dustmeter device according to Euroseeds reference method “Assessment of free floating dust and abrasion particles of treated seeds as a parameter of the quality of treated seeds”, which is lower by at least 30% as compared to an analogous binder-free composition that does not contain the rosin-based resin. The Heubach dustmeter can be set with values such as rotation speed (from 1 rpm to 100 rpm), rotation time (1 sec to 500 seconds), airflow rate (from 1 L/min to 500 L/min).

In one embodiment, the Heubach dustmeter is set with the following parameters: rotation speed 30 rpm, rotation time 120 seconds and airflow rate 20 L/min.

As mentioned previously, a reduction in dust-off results in decreased risk of contamination of equipment and environment, and thus in improved working conditions for workers. A reduction in dust-off also results in cleaner seed treatment machinery, which reduces downtime in the necessity of cleaning the machinery.

Dust residue from seed treatment product may result in unwanted build-up and contamination (e.g. differing seed treatments and/or doses) in the seed treatment machinery. The present invention also provides for a reduction in seed treatment residue build-up in the treatment machinery.

In another embodiment, the composition is characterized by a dust value, as measured using a Heubach dustmeter device according to Euroseeds reference method “Assessment of free floating dust and abrasion particles of treated seeds as a parameter of the quality of treated seeds”, which is lower by at least 40%, or which is lower by at least 50%, or which is lower by at least 60%, or which is lower by at least 70%, or which is lower by at least 80%, as compared to an analogous binder-free composition that does not contain the rosin-based resin.

In one embodiment, the Heubach dustmeter is set with the following parameters: rotation speed: 60 rpm, rotation time: 240 seconds and airflow rate 20 L/min. In one embodiment, the Heubach dustmeter is set with the following parameters: rotation speed: 20-40 rpm, rotation time: 90-150 seconds and airflow rate 10-30 L/min.

In another embodiment, the seed coating composition contains at least one active ingredient.

The active ingredient can be for instance any one or more of: plant nutrients, growth stimulating agents, and plant protection products.

According to the invention, the term “plant nutrient” includes any nutrient such as a micronutrient or macronutrient. “Nutrient” as used herein can refer to an additive or substance utilized by plants, grasses, shrubs for plant, grass, and shrub growth, respectively. Macronutrients can be utilized in larger amounts by plants, grasses, etc. in proportionally larger amounts relative to micronutrients. Nutrients include but are not limited to manganese, boron, copper, iron, chlorine, molybdenum, and zinc, potassium, nitrogen, calcium, magnesium phosphorus and sulfur, among others. Compositions of the present invention can include various combinations and relative amounts of individual macronutrients.

According to the invention, the term “growth stimulating agents” includes biological additives, such as inoculants type bacteria or fungi, as well as plant biostimulants. Plant biostimulants are usually components other than fertilizers that affect plant growth and/or metabolism upon foliar application or when added to soil. Plant biostimulants generally fall within one of three categories: hormone-containing products, amino acid-containing products and humic acid-containing products. Plant biostimulants are used to treat crops in a commercial setting in view of their ability to, for example, increase growth rates, decrease pest plant growth, increase stress tolerance, increase photosynthetic rate, and increase disease tolerance.

According to the invention, the term “plant protection product” includes any pesticide such as especially herbicides, fungicides or insecticides, preferably fungicides or insecticides.

Suitable examples of active ingredients of the invention include fungicidal agents, bactericidal agents, insecticidal agents, nematicidal agents, molluscicidal agents, acaricides or miticides, pesticides, and biocides. Further possible active ingredients include disinfectants, micro-organisms, rodent killers, weed killers (herbicides), attracting agents, (bird) repellent agents, plant growth regulators (such as gibberellic acid, auxin or cytokinin), nutrients (such a potassium nitrate, magnesium sulphate, iron chelate), plant hormones, minerals, plant extracts, germination stimulants, pheromones, biological preparations, etc.

The amount of active ingredient applied, of course, strongly depends on the type of active ingredient and the type of seed used. Usually, however, the amount of one or more active ingredients is in the range of 0.001-200 g per kg of the seed. The skilled person is able to determine suitable amounts of active ingredient depending on the active ingredient and the type of seed used.

It is understood that the term “seed” or “seedling” is not limited to a specific or particular type of species or seed. The term “seed” or “seedling” can refer to seed from a single plant species, a mixture of seed from multiple plant species, or a seed blend from various strains within a plant species.

In one embodiment, crop seeds include but are not limited to rice, corn, wheat, barley, oats, soybean, cotton, sunflower, alfalfa, sorghum, rapeseed, sugarbeet, tomato, bean, carrot, tobacco or flower seeds.

In one embodiment, the seed is selected from the following crops or vegetables: corn, wheat, sorghum, soybean, tomato, cauliflower, radish, cabbage, canola, lettuce, rye grass, grass, rice, cotton, sunflower and the like. In another embodiment, the seed is selected from corn, wheat, barley, rice, peas, oats, soybean, sunflower, alfalfa, sorghum, rapeseed, sugar beet, cotton, tobacco, forage crops, linseed, hemp, grass, vegetables, fruits and flowers seeds.

In one embodiment, the seed is of the crop or plant species including but not limited to corn (Zea mays), Brassica sp. (e.g., B. napus, B. rapa, B. juncea), alfalfa (Medicago sativa), rice (Oryza sativa), rye (Secale cereale), sorghum (Sorghum bicolor, Sorghum vulgare), millet (e.g., pearl millet (Pennisetum glaucum), proso millet (Panicum miliaceum), foxtail millet (Setaria italica), finger millet (Eleusine coracana)), sunflower (Helianthus animus), safflower (Carthamus tinctorius), wheat (Triticum aestivum), soybean (Glycine max), tobacco (Nicotiana tabacum), potato (Solanum tuberosum), peanuts (Arachis hypogaea), cotton (Gossypium barbadense, Gossypium hirsutum), sweet potato (Ipomoea batatus), cassava (Manihot esculenta), coffee (Cofea spp.), coconut (Cocos nucifera), pineapple (Ananas comosus), citrus trees (Citrus spp.), cocoa (Theobroma cacao), tea (Camellia sinensis), banana (Musa spp.), avocado (Persea americana), fig (Ficus casica), guava (Psidium guajava), mango (Mangifera indica), olive (Olea europaea), papaya (Carica papaya), cashew (Anacardium occidentale), macadamia (Macadamia integrifolia), almond (Prunus amygdalus), sugar beets (Beta vulgaris), sugarcane (Saccharum spp.), oats, barley, vegetables, ornamentals, woody plants such as conifers and deciduous trees, squash, pumpkin, hemp, zucchini, apple, pear, quince, melon, plum, cherry, peach, nectarine, apricot, strawberry, grape, raspberry, blackberry, soybean, sorghum, sugarcane, rapeseed, clover, carrot, and Arabidopsis thaliana.

In one embodiment, the seed is of any vegetables species including but not limited to tomatoes (Lycopersicon esculentum), lettuce (e.g., Lactuca sativa), green beans (Phaseolus vulgaris), lima beans (Phaseolus limensis), peas (Lathyrus spp.), cauliflower, broccoli, turnip, radish, spinach, asparagus, onion, garlic, pepper, celery, and members of the genus Cucumis such as cucumber (C. sativus), cantaloupe (C. cantalupensis), and musk melon (C. melo).

In one embodiment, the seed is of any ornamentals species including but not limited to hydrangea (Macrophylla hydrangea), hibiscus (Hibiscus rosasanensis), petunias (Petunia hybrida), roses (Rosa spp.), azalea (Rhododendron spp.), tulips (Tulipa spp.), daffodils (Narcissus spp.), carnation (Dianthus caryophyllus), poinsettia (Euphorbia pulchenima), and chrysanthemum.

In one embodiment, the seed is of any conifer species including but not limited to conifers pines such as loblolly pine (Pinus taeda), slash pine (Pinus elliotii), ponderosa pine (Pinus ponderosa), lodgepole pine (Pinus contorta), and Monterey pine (Pinus radiata), Douglas-fir (Pseudotsuga menziesii); Western hemlock (Tsuga canadensis); Sitka spruce (Picea glauca); redwood (Sequoia sempervirens); true firs such as silver fir (Abies amabilis) and balsam fir (Abies balsamea); and cedars such as Western red cedar (Thuja plicata) and Alaska yellow-cedar (Chamaecyparis nootkatensis).

In one embodiment, the seed is of any leguminous plant species including but not limited beans and peas. Beans include guar, locust bean, fenugreek, soybean, garden beans, cowpea, mungbean, lima bean, fava bean, lentils, chickpea, pea, moth bean, broad bean, kidney bean, lentil, dry bean, etc. Legumes include, but are not limited to, Arachis, e.g., peanuts, Vicia, e.g., crown vetch, hairy vetch, adzuki bean, mung bean, and chickpea, Lupinus, e.g., lupine, trifolium, Phaseolus, e.g., common bean and lima bean, Pisum, e.g., field bean, Melilotus, e.g., clover, Medicago, e.g., alfalfa, Lotus, e.g., trefoil, lens, e.g., lentil, and false indigo. Typical forage and turf grass for use in the methods described herein include but are not limited to alfalfa, orchard grass, tall fescue, perennial ryegrass, creeping bent grass, lucerne, birdsfoot trefoil, clover, stylosanthes species, lotononis bainessii, sainfoin and redtop. Other grass species include barley, wheat, oat, rye, orchard grass, guinea grass, sorghum or turf grass plant.

In one embodiment, the at least one layer is comprised of several binders. For example, a layer can be comprised of at least two binders (a first binder, second binder), or can be comprised of at least three binders (a first binder, a second binder, a third binder, etc.), or can be comprised of at least four binders (a first binder, a second binder, a third binder, a fourth binder, a fifth binder, a sixth binder, etc.).

In one embodiment, the layer coating all or part of the seed, in a coated seed composition of the invention, comprises in addition to said rosin-based resin at least one second binder.

Additional optional binder can be any suitable binder approved for agricultural use. One such list of suitable binders can be found in the U.S. Code of Federal Regulations Title 40, Part 180.960 (referred to hereafter as 40CFR 180.960).

Included in this list approved binders are acrylic polymers composed of one or more of the following monomers: acrylic acid, methyl acrylate, ethyl acrylate, butyl acrylate, hydroxyethyl acrylate hydroxybutyl acrylate, carboxyethyl acrylate, methacrylic acid, methyl methacrylate, hydroxy butyl methacrylate, lauryl methacrylate, and stearyl methacrylate; with none and/or one or more of the following monomers: acrylamide, N-methyl acrylamide, N,N-dimethyl acrylamide, N-octyl acrylamide, maleic anhydride, maleic acid, monoethyl maleate, diethyl maleate, monooctyl maleate, dioctyl maleate; and their corresponding sodium, potassium, ammonium, isopropylamine, triethylamine, monoethanolamine, and/or triethanolamine salts. Other suitable binders from this list include: copolymers of methyl vinyl ether with maleic anhydride or monoalkyl esters of maleic anhydride (e.g. Agrimer® VEMA line of products from ISP); polyvinylpyrrolidone; copolymers of vinyl pyrrolidone with vinyl acetate (e.g., Agrimer VA line of products from ISP); copolymers of vinyl pyrrolidone with vinyl alkyls (e.g. Agrimer® AL line of products from ISP); polyvinyl acetate; ethylene/vinyl acetate copolymers (e.g. Atlox® SemKote E product line from Uniqema); vinyl acetate acrylic copolymers (e.g., Atlox® Semkote V product line from Uniqema); A-B block copolymers of ethylene oxide and propylene oxide; A-B-A triblock copolymers of EO-PO-EO (e.g. Pluronics® line from BASF); polyvinyl alcohol, styrene acrylic polymers and vinyl acetate-versatate polymers.

The additional optional binder may be a latex polymer, i.e. a dispersion in an aqueous carrier of polymer particles having a particle size of about 0.05-0.20 microns and a weight average molecular weight of greater than 500,000 g/mol. Latex polymers may be formed by conventional emulsion polymerization.

Preferably, the additional optional binder is chosen from biodegradable binders.

In one embodiment, the additional optional binder may be a biodegradable polymer.

As used herein, a polymer is biodegradable if is not water soluble, but is degraded over a period of several weeks when placed in an application environment. Examples of biodegradable polymers include biodegradable polyesters; starch-polyester alloys; starch; starch-PCL blends; polylactic acid (PLA)-starch blends; polylactic acid; poly(lactic acid-glycolic acid) copolymers; PCL; polygalactomannans, such as derivatized or non-derivatized guars; cellulose esters; cellulose acetate butyrate; starch esters; starch ester-aliphatic polyester blends; modified corn starch; polycaprolactone; poly(n-amylmethacrylate); ethyl cellulose; wood rosin; polyanhydrides; polyvinylalcohol (PVOH); polyhydroxybutyrate-valerate (PHBV); biodegradable aliphatic polyesters; and polyhydroxybutyrate (PHB).

In one embodiment, the layer coating all or part of the seed, in a coated seed composition of the invention, comprises in addition to said rosin-based resin at least one second binder comprising a crosslinked polymer has an average particle size of less than about 400 nm.

In one embodiment, a crosslinked polymer has an average particle size of less than about 400 nm, or in another embodiment has an average particle size of less than about 600 nm, or in another embodiment has an average particle size of less than about 800 nm. In a further embodiment, the crosslinked polymer has an average particle size of less than 1000 nm, or 900 nm, or 800 nm, or 700 nm, or 600 nm, or 500 nm, or 300 nm, or 200 nm. In another embodiment, the crosslinked polymer has an average particle size of less than 200 nm, or 175 nm, or 150 nm, or 125 nm, or 100 nm, or 75 nm, or 50 nm, or 25 nm. In one embodiment, the crosslinked polymer is a concentrated and stable dispersion of a crosslinked polymer.

In one embodiment, the crosslinked polymer is a biopolymer, which is amylose or amylopectin.

In one embodiment, the layer is comprised of at least a first binder comprising a rosin-based resin and a second binder comprising the said crosslinked biopolymer.

In one embodiment, the biopolymer is a starch, which can be amylose, amylopectin, or a combination thereof. In some embodiments, the starch is crosslinked, typically, internally crosslinked. In further embodiments, the internally crosslinked starch (including amylose and amylopectin) is made up of particles having an average particle size under 400 nm. In another embodiment, the internally crosslinked starch (including amylose and amylopectin) is made up of particles having an average particle size in the range of 50 to 150 nm. The product can be in the form of a dry powder of agglomerated nanoparticles with a volume mean diameter of about 300 microns.

The crosslinking agents utilized can include but are not limited to copper compounds, magnesium compounds, borax, glyoxal, zirconium compounds, titanium compounds (for example, titanium IV compounds such as titanium lactate, titanium malate, titanium citrate, titanium ammonium lactate, polyhydroxy complexes of titanium, titanium triethanolamine, and titanium acetylacetonate), calcium compounds, aluminum compounds (such as, for example, aluminum lactate or aluminum citrate), p-benzoquinone, dicarboxylic acids and their salts, phosphite compounds and phosphate compounds. In another embodiment, the crosslinking agent is a chemical compound containing a polyvalent ion such as, but not necessarily limited to, boron or a metal such as chromium, iron, aluminum, titanium, antimony and zirconium, or mixtures of polyvalent ions. In another embodiment, crosslinking agent is a polyacid comprising at least two acidic functional groups reacting with the alcohol moieties on the starch particles. In one embodiment, the polyacid is nonpolymeric. The polyacids can include at least one of citric acid, glutaric acid, maleic acid, succinic acid, phthalic acid, malic acid, phthalic acid or the like, and salts thereof.

In another embodiment, the crosslinking agent is selected from dialdehydes, polyaldehydes, anhydrides, glutaraldehyde, glyoxal, oxidized carbohydrates, periodate-oxidized carbohydrates, epichlorohydrin, distarch phosphate, epoxides, triphosphates, borax, isocyanates, and silicates such as tetraethyl orthosilicate (TEOS). In one embodiment, the crosslinking agent is a mixture of crosslinking agents.

In one embodiment, the crosslinking agent can used at between 0.1 and 10% by weight with respect to the total dry weight of the curable aqueous composition, and, in another embodiment, between 0.1 and 5 weight % with respect to the total dry weight of the curable aqueous composition. In yet another embodiment, the crosslinking agent can be used between 0.5 and 5% by weight with respect to the total dry weight of the curable aqueous composition, or between 0.1 and 2% by weight with respect to the total dry weight of the curable aqueous composition.

In one exemplary embodiment, the present invention relates to the combined use of at least one rosin-based resin and a starch as defined previously, as binder in seed coating compositions.

The present invention relates in particular to the use of a mixture comprising at least one rosin-based resin and a starch as defined previously, as binder in seed coating compositions.

The present invention relates more especially to a coated seed composition comprising at least one seed and at least one layer coating all or part of the seed, the layer comprising at least a mixture of one rosin-based resin and of a starch as defined previously as binder.

It has been found unexpectedly that the combined use of at least one rosin-based resin and a starch as defined previously, as binder in seed coating compositions made it possible to achieve outstanding performances for seed coating applications, especially when the rosin-based resin has a Ring and Ball softening point ranging from about 10° C. to about 65° C., for instance from about 20° C. to about 60° C., for instance from about 30° C. to about 55° C., for instance from about 35° C. to 50° C.

As demonstrated in the Examples, it is indeed advantageous to use a mixture comprising at least one rosin-based resin having s a Ring and Ball softening point as defined previously (lower than or equal to 65° C., especially lower than or equal to 60° C., for instance from about 30° C. to about 55° C., for instance from about 35° C. to 50° C.) together with a starch as defined previously, as binder in seed coating composition since it has been found that such a mixture exhibits an appropriate viscosity while maintaining good performance especially in dust-off reduction.

According to one embodiment, the binder composition may exhibit a Brookfield viscosity at 20° C., 20 rpm (Brookfield apparatus LV) lower than 3,000 cP, especially lower than 2,500 cP.

In one embodiment, the present invention relates to a method for preparing a coated seed composition having dust suppression benefits comprising the step of contacting at least a portion of at least one seed with at least one layer comprising at least a mixture of one rosin-based resin, preferably having a Ring and Ball softening point ranging from about 10° C. to about 65° C., for instance from about 20° C. to about 60° C., for instance from about 30° C. to about 55° C., for instance from about 35° C. to 50° C., together with a starch as defined previously,

wherein the coated seed composition is characterized by a dust value, as measured using a Heubach dustmeter device according to Euroseeds reference method “Assessment of free floating dust and abrasion particles of treated seeds as a parameter of the quality of treated seeds”, which is lower by at least 30% as compared to an analogous binder-free composition that does not contain the said mixture.

In one embodiment, the present invention relates to the use of at least a mixture of one rosin-based resin, preferably having a Ring and Ball softening point ranging from about 10° C. to about 65° C., for instance from about 20° C. to about 60° C., for instance from about 30° C. to about 55° C., for instance from about 35° C. to 50° C., together with a starch as defined previously, as binder for seed coating applications, for instance to provide dust suppression benefits.

In one embodiment, the relative amount of the rosin-based resin in the binder would typically be such that the amount (dry solids content) of rosin-based resin actually applied onto the seed is lower than 3 wt %, relative to the total weight of the seed, for instance lower than 2.8 wt %, for instance lower than 2.5 wt %, for instance ranging from 0.0001 and 2.5 wt %, relative to the total weight of the seed, for instance between 0.001 and 2.5 wt %, for instance between 0.005 and 2.5 wt %.

In one embodiment, the rosin-based resin as defined previously and the starch as defined previously, may be present in the mixture of the invention in a relative weight ratio, expressed in dry solids content, [rosin-based resin: starch] greater than 0.5, for instance greater than 0.6, for instance greater than 0.8, for instance greater than 1, and especially lower than 100, for instance lower than 50, for instance lower than 20, for instance lower than 10.

In one embodiment, the rosin-based resin having s a Ring and Ball softening point as defined previously (namely lower than or equal to 65° C., especially lower than or equal to 60° C., for instance from about 30° C. to about 55° C., for instance from about 35° C. to 50° C.) and the starch as defined previously, may be present in the mixture of the invention in a relative weight ratio, expressed in dry solids content, [rosin-based resin: starch] greater than 0.5, for instance greater than 0.6, for instance greater than 0.8, for instance greater than 1, and especially lower than 100, for instance lower than 50, for instance lower than 20, for instance lower than 10.

In one embodiment, when the binder of the invention comprises a mixture of a rosin-based resin as defined previously and of a starch as defined previously, the relative amount of said starch in the binder would typically be such that the amount (dry solids content) of starch actually applied onto the seed is lower than 0.050 wt %, relative to the total weight of the seed, for instance lower than 0.045 wt %, for instance lower than 0.040 wt %, for instance ranging from 0.0005 and 0.045 wt %, relative to the total weight of the seed.

In particular, according to one embodiment, when the binder of the invention comprises a mixture of a rosin-based resin having s a Ring and Ball softening point as defined previously (namely lower than or equal to 65° C., especially lower than or equal to 60° C., for instance from about 30° C. to about 55° C., for instance from about 35° C. to 50° C.) and of a starch as defined previously, the relative amount of said starch in the binder would typically be such that the amount (dry solids content) of starch actually applied onto the seed is lower than 0.050 wt %, relative to the total weight of the seed, for instance lower than 0.045 wt %, for instance lower than 0.040 wt %, for instance ranging from 0.0005 and 0.045 wt %, relative to the total weight of the seed.

In other embodiments, the seed coating composition may further comprise a cationic compound selected from the following: homopolymers and copolymers of cationic styrenic monomers, homopolymers and copolymers of cationic allylic monomers, homopolymers and copolymers of (meth)acrylamido cationic monomers, homopolymers and copolymers of (meth)acrylate cationic monomers, polyvinylamine, cationic polyacrylamide, cationic polyvinyl alcohol, Polyquaternium-2; polyureylene ammonium salt, cationic starch, cationic cellulose, cationic hydroxyl-ethyl cellulose, cationic xanthan gum, cationic carageenan gum, cationic karaya gum, cationic arabic gum, cationic Lara gum, cationic canafen gum, cationic cassia gum, cationic konjac gum, cationic daincha, cationic fenugreek gum, cationic locust bean gum, cationic psyllium seed gum, cationic konjak, cationic mesquite gum, cationic ivory nut mannan gum, cationic alginate, cationic agar, cationic ulvane, cationic tragacanth gum, cationic ghatti gum, cationic tamarind gum, cationic xyloglucan, cationic inulin, cationic proteins, cationic pectin, cationic hemicellulose or cationic guars, such as cationic hydroxypropyl guars.

The seed coating composition may contain also surfactants, antioxidants, plasticizers, colorants, fillers, drying powder type silica (including fumed or precipitated silica), kaolin, talc, or a mixture thereof.

The filler can comprise for instance: wood flours, clays, activated carbon, carbohydrates, sugars, dextrins, maltodextrins, diatomaceous earth, cereal flours, wheat flour, oat flour, barley flour, calcium carbonate, calcium bentonite, kaolin, china clay, talc, perlite, mica, vermiculite, silicas, quartz powder, montmorillonite and/or mixtures thereof.

According to one embodiment, the seed coating composition is free from any metal complex growth-promoting additive, such as manganese, iron, copper, molybdenum, zinc and mixtures thereof.

In one embodiment, the seed has a shelf-life at room temperature in ambient conditions in an unsealed container without added salts or adjuvants of at least two months.

In one embodiment, the coating compositions of the invention promote seedling establishment and plant growth as one or more layers of the coating composition aids as a carrier or retention agent for active ingredients. In one embodiment, the coating compositions of the invention help to maintain the distribution of said active ingredient during the application of the treatment.

The seed coating composition may be a liquid or solid composition, notably a powder. Suitable coating techniques may be utilized to coat the seeds or agglomeration of seed of the seed coating compositions described herein. Equipment that may be utilized for coating can include but are not limited to drum coaters, rotary coaters, tumbling drums, fluidized beds and spouted beds, but any suitable equipment or technique may be employed. The seeds may be coated via a batch or continuous coating process.

The method of the invention comprises applying a seed coating composition to seed. Preferably, the coating composition is applied as a liquid composition and/or latex composition and thereafter solidified (including cured and/or dried) to form a seed coating. The term “liquid coating composition” as used in this application is meant to include coating compositions in the form of a suspension, solution, emulsion, or dispersion.

Conventional means of coating may be employed for coating the seeds. Various coating machines are available to the person skilled in the art. Some well-known techniques include the use of drum coaters, fluidised bed techniques, rotary coaters (with and without integrated drying), and spouted beds. Suitably, the seed coating composition is applied to the seed by a rotary coater, a rotary dry coater, a pan coater or a continuous treater. The seed coating composition can, for instance, be applied by film coating, spraying, dipping, or brushing of the seed coating composition.

Typically, the amount of seed coating slurry applied to the seed is in the range of 0.5-50 g per kg seed, such as 1-40 g per kg seed, for instance 1-35 g per kg seed, or 1-30 g per kg seed. In one embodiment, the amount of seed coating slurry applied to the seed is in the range of 2-35 g per kg seed, or 3-30 g per kg seed.

Typically, the amount of binder (active material) in the seed coating composition is normally in the range of 0.01-100 g per kg of the seed, preferably 0.01-50 g per kg of the seed, more preferably 0.05-20 g per kg of the seed, and for instance 0.1-10 g per kg of the seed.

Typically, the amount of the binder (active material) in the coating slurry is 0.01% by weight or more by total weight of the coating composition, preferably 0.05% by weight or more, for instance 0.5% by weight or more. In one embodiment, the amount of the binder (active material) in the coating composition is 1% by weight or more by total weight of the coating composition, for instance at least 2% by weight, preferably at least 3% by weight of the coating composition.

Typically, the amount of the binder in the coating composition is 50% by weight or less by total weight of the coating composition, preferably 30% by weight or less.

In a first embodiment, the invention also concerns a method to increase the growth of a plant by coating a seed of said plant with a composition comprising at least one of the above mentioned compounds in a first step and then in a second step to apply the coated seed onto or in the soil; notably in order to set in contact the coated seed with the ground.

In another embodiment, the invention also concerns a method to increase the growth of a plant in which it's perfectly possible to set an “in situ coating” onto or in the soil; notably by implanting in a hole in the soil a raw or non-coated seed of plant and then applying a coating composition comprising at least one of the above mentioned compounds, into the hole to surround or partially surround the seed.

The seeds can be separated prior to coating which, in one embodiment, utilizes mechanical means such as a sieve. The separated seeds can then be introduced into a coating machine having a seed reservoir. In one embodiment, the seeds in the mixing bowl are combined with one or more of the coatings described herein and adhered with a binder or adhesive.

It is an object of this invention to provide a method, which is easily carried out and easily applied using conventional and commercially available application equipment.

In one embodiment of the process, one or more layers can be added to coat the seed or agglomeration. Outer layers can be introduced sequentially to the rotating drum. In another embodiment, agglomerators or agglomerator devices may also be utilized. Coating is performed within a rotary coater by placing seeds within a rotating chamber, which pushes the seeds against the inside wall of the chamber. Centrifugal forces and mixing bars placed inside the coater allow the seed to rotate and mix with a coating layer. Binder or other coating materials can be pumped into the proximate center of the coater onto an atomizer disk that rotates along with the coating chamber. Upon hitting the atomizer disk, liquid adhesive is then directed outward in small drops onto the seed.

In one embodiment, seed coating techniques include, for example, including seed(s) in a rotating pan or drum. The seed is then mist with water or other liquid and then gradually a fine inert powder, e.g., diatomaceous earth, is added to the coating pan. Each misted seed becomes the center of a mass of powder, layers, or coatings that gradually increases in size. The mass is then rounded and smoothed by the tumbling action in the pan, similar to pebbles on the beach. The coating layers are compacted by compression from the weight of material in the pan. Binders often are incorporated near the end of the coating process to harden the outer layer of the mass. Binders can also reduce the amount of dust produced by the finished product in handling, shipping and sowing. Screening techniques, such as frequent hand screening, are often times utilized to eliminate blanks or doubles, and to ensure uniform size. For example, tolerance for seed coating compositions described herein can be +/−0.4 mm ( 1/64th inch), which is the US seed trade standard for sizing, established long before coatings were introduced. For example, coated lettuce seed is sown most frequently with a belt planter through a 5.1 mm ( 13/64 inch) diameter round holes in the belt. This hole size requires that the seed coating compositions comprising lettuce seeds can be sized over a 190.5 mm (7.5/64 inch) screen and through an 215.9 mm (8.5/64 inch) screen.

In another embodiment, the seed coating compositions and methods described herein comprises “in situ coating”. In situ coating means, in one embodiment, where a raw or non-coated seed is implanted in a hole in the ground and immediately or soon thereafter a coating composition is sprayed or applied directly into the hole to surround or partially surround the seed. According to the invention the hole may notably be a hole, a cavity or a hollowed area, Typically, the application of the seed as well as application of the coating composition are performed mechanically, but is understood that either or both of the referenced applications can be performed manually as well.

In some embodiments, one or more layers described herein can act as a “film-coating. A thin film can smooth the surface of the seed coating composition for better flow ability. The film-coating also influences water uptake and the adherence of additional ingredients, such as for example chemical fungicide treatments. In some embodiments, film coating only increases the raw weight of the seed or agglomerates 1% to 5%, far less than traditional powder coatings. In some embodiments, up to 10%, in other embodiment up to 25%, up to, 15%, 40%, 50%.

In one embodiment, a seed is typically coated when the non-coated or raw seed is too small, light or variable in shape or size to be sown accurately with equipment currently used. Thus, it is desirable for farmers, growers, etc. to be able to precisely sow a crop. Such precision sowing is desirable when growers need strict control of spacing or depth of placement. This is also important for crops that are direct sown and then thinned back to the desired population, i.e., field thinning. Incidence of “skips” or “doubles” can be reduced and seedlings can be more accurately spaced (for example, with a deviation of less than 12.7 mm (0.5 inches) on center in the row as opposed to traditional techniques with deviations of greater than several inches). In some instances, it is desirable to agglomerate two or more seeds to create a uniform size for improved or efficient sowing.

An aspect of the invention includes agglomerates of seed. The agglomerate or grouping of seed, in one embodiment, is a grouping of 2 or more individual seeds together. In another embodiment, the agglomerate is a grouping of more than 5 individual seeds together. In a further embodiment, the agglomerate is a grouping of more than 10 individual seeds together. In yet another embodiment, the agglomerate is a grouping of more than 25 individual seeds together. In yet a further embodiment, the agglomerate is a grouping of more than 50 individual seeds together. In another embodiment, the agglomerate is a grouping of more than 100 individual seeds together.

In one embodiment, the seed coating composition is of substantially uniform size of from between 10 micrometers and 4 mm in diameter. In another embodiment, the seed coating composition is of substantially uniform size of from between 25 micrometers and 2 mm in diameter. In a further, the seed coating composition is of substantially uniform size of from between 500 micrometers and 2 mm in diameter.

The following examples are included to illustrate embodiments of the invention, but is not limited to described examples.

### EXAMPLES

### Example 1

Seed treatment formulation containing two fungicide slurries, water and a dispersion of rosin-based resin are prepared by mixing all the components by magnetic agitation. The formulation without rosin-based resin is considered as the control. A commercial styrene acrylic latex dispersion (SAL) was utilized as a benchmark and applied at the recommended dose rate: 20 mL/qt. Corn seeds of the variety A were treated with the different formulations with a laboratory seed coater Norogard R150 as follows: weight seeds and introduce them into the seed coater chamber, turn on seed coater (300 rpm), introduce seed treatment slurry, turn off seed coater (after 15 seconds of rotation) and discharge the treated seeds. The compositions of seed treatment formulations applied on seeds are detailed in Table 1.

TABLE 1

| | Formulation | Formulation | Formulation |
|---|---|---|---|
| Component | 1 | 2 | 3 |
| Fungicide slurry 1 | 75 mL/qt | 75 mL/qt | 75 mL/qt |
| Fungicide slurry 2 | 250 mL/qt | 250 mL/qt | 250 mL/qt |
| Water | 690 mL/qt | 690 mL/qt | 690 mL/qt |
| SAL (benchmark) | — | 20 mL/qt | — |
| Dispersion of rosin-based | — | — | 35 mL/qt |
| resin 1^{a)} | | | |

The coating processability of the different formulations was evaluated through three criteria: caking, wetness and residue. ^{a)} Dispersion of rosin-based resin 1: dispersion of rosin acid with a solids equals to 57% and a softening point to 75° C.

Caking evaluation was evaluated with the following protocol: a solid container was filled with freshly treated seeds, the container is kept at rest for 15 minutes without any mechanical disturbance, after 15 minutes the container is tilted until the seeds start to flow and the formation of any seed aggregates is monitored. If no aggregates are formed the test results is PASS, if some seeds aggregates are observed the rest results is NOT PASS.

For wetness criteria, the seeds were observed just after treatment and their wetness was visually evaluated ranging from: dry, slightly wet and wet.

For residue criteria, the seed coater chamber just after treatment was observed to qualitatively evaluate the amount of residual ranging from: no residual, slightly residual, high amount of residual. The results of the caking tests, wetness and residuals observations are presented in Table 2.

TABLE 2

| | | | F3 (rosin-based |
|---|---|---|---|
| | F1 (reference) | F2 (benchmark) | resin) |
| Caking result | PASS | PASS | PASS |
| Wetness result | dry | dry | Dry |
| Residual result | No residual | No residual | No residual |

As shown in Table 2, no caking issue were observed. All the formulations tested were able to coat seeds easily.

Dust measurements were also performed on the seeds treated with the different formulations with a Heubach dustmeter equipment according to Euroseeds reference method “Assessment of free floating dust and abrasion particles of treated seeds as a parameter of the quality of treated seeds”. Treated seeds are introduced in the metal drum of the Heubach device, the drum is then reassembled and connected to the glass cylinder. A glass fiber filter disc is placed in the filter unit, the filter unit is then weighted and after placed on the glass cylinder and connected to the vacuum tube. The drum is put in rotation (30 rpm). The vacuum pump creates an air flow through the rotating drum, by the air flow the abraded dust particle are transported out of the rotating drum through the glass cylinder and the filter unit. At the end of the rotation, the filter unit is removed from the glass cylinder and weight. The Heubach dust value is expressed in g/100 kg of treated seeds and is calculated as the ratio of the weight difference of the filter unit after and before the test and the weight of treated seeds. The test is performed twice, the final results is the mean of the two measurements. The settings of the Heubach equipment are set as follows: rotation speed 60 rpm, rotation time 240 seconds, seed quantity 200 g and airflow rate 20 L/min. The dust measurements are performed on seeds treated with the different formulations. The results are summarized in Table 3.

TABLE 3

| | Dust level | Standard |
|---|---|---|
| Binder | (g/100 kg) | deviation |
| Control | 5.8 | 0.25 |
| SAL (Benchmark) | 1.8 | 0.03 |
| Dispersion of rosin-based resin 1^{a)} 35 mL/qt | 2.0 | 0.4 |

The two binders reduce the dust emission compared to the control seeds. Comparable performances in terms of dust reduction are obtained for the benchmark and the dispersion of rosin-based resin 1 at 35 mL/qt. ^{a)} Dispersion of rosin-based resin 1: dispersion of rosin acid with a % solids equals to 57% and a softening point to 75° C.

### Example 2

Seed treatment formulation containing two fungicide slurries, water and different dispersions of rosin-based resin are prepared by mixing all the components by magnetic agitation. The formulation without rosin-based resin is considered as the control. A commercial styrene acrylic latex dispersion (SAL) was utilized as a benchmark and applied at the recommended dose rate 20 mL/qt and at a higher dose rate 70 mL/qt. Corn seeds of the variety B were treated with the different formulations with a laboratory seed coater Norogard R150 as follows: weight seeds and introduce them into the seed coater chamber, turn on seed coater (300 rpm), introduce seed treatment slurry, turn off seed coater (after 15 seconds of rotation) and discharge the treated seeds. The compositions of seed treatment formulations applied on seeds are detailed in Table 4.

TABLE 4

| Component | Formulation 5 | | Formulation 6 | | Formulation 7 | | Formulation 8 | | Formulation 9 | | Formulation 10 | | Formulation 11 | |
|---|---|---|---|---|---|---|---|---|---|---|---|---|---|---|
| Fungicide slurry 1 | 75 | mL/qt | 75 | mL/qt | 75 | mL/qt | 75 | mL/qt | 75 | mL/qt | 75 | mL/qt | 75 | mL/qt |
| Fungicide slurry 2 | 250 | mL/qt | 250 | mL/qt | 250 | mL/qt | 250 | mL/qt | 250 | mL/qt | 250 | mL/qt | 250 | mL/qt |
| Water | 690 | mL/qt | 690 | mL/qt | 690 | mL/qt | 690 | mL/qt | 690 | mL/qt | 690 | mL/qt | 690 | mL/qt |

| | | | | | | | | | |
|---|---|---|---|---|---|---|---|---|---|
| SAL (benchmark) | — | 20 | mL/qt | 70 | mL/qt | — | — | — | — |

| | | | | | | | | |
|---|---|---|---|---|---|---|---|---|
| Dispersion of rosin- | — | — | — | — | — | 35 | mL/qt | — |
| based resin 1^{a)} | | | | | | | | |

| | | | | | | | | | |
|---|---|---|---|---|---|---|---|---|---|
| Dispersion of rosin- | — | — | — | 70 | mL/qt | 35 | mL/qt | — | — |
| based resin 2^{b)} | | | | | | | | | |

| | | | | | | | | |
|---|---|---|---|---|---|---|---|---|
| Dispersion of rosin- | — | — | — | — | — | — | 35 | mL/qt |
| based resin 3^{c)} | | | | | | | | |

^{a)}Dispersion of rosin-based resin 1: dispersion of rosin acid with a % solids equals to 57% and a softening point to 75° C.
^{b)}Dispersion of rosin-based resin 2: dispersion of modified rosin ester with a % solids equals to 54% and a softening point to 45° C.
^{c)}Dispersion of rosin-based resin 3: dispersion of rosin ester with a % solids equals to 56% and a softening point to 76° C.

The coating processability of the different formulations was evaluated through three criteria: caking, wetness and residue.

Caking evaluation was evaluated with the following protocol: a solid container was filled with freshly treated seeds, the container is kept at rest for 15 minutes without any mechanical disturbance, after 15 minutes the container is tilted until the seeds start to flow and the formation of any seed aggregates is monitored. If no aggregates are formed the test results is PASS, if some seeds aggregates are observed the rest results is NOT PASS.

For wetness criteria, the seeds were observed just after treatment and their wetness was visually evaluated ranging from: dry, slightly wet and wet.

For residue criteria, the seed coater chamber just after treatment was observed to qualitatively evaluate the amount of residual ranging from: no residual, slightly residual, high amount of residual. The results of the caking tests, wetness and residuals observations are presented in Table 5.

TABLE 5

| | | | | F8 | F9 | F10 | F11 |
|---|---|---|---|---|---|---|---|
| | F5 | F6 | F7 | (rosin-based | (rosin-based | (rosin-based | (rosin-based |
| | (reference) | (benchmark) | (benchmark) | resin 2) | resin 2) | resin 1) | resin 3) |
| Caking | PASS | PASS | PASS | PASS | PASS | PASS | PASS |
| result | | | | | | | |
| Wetness | dry | dry | dry | Dry | dry | dry | dry |
| result | | | | | | | |
| Residual | No | No | No | No | No | No | No |
| result | residual | residual | residual | Residual | residual | residual | residual |

As shown in Table 5, no caking issues were observed for any of the formulations tested. All the formulations tested were able to coat seeds easily.

Dust measurements were also performed on the seeds treated with the different formulations with a Heubach dustmeter equipment according to Euroseeds reference method “Assessment of free floating dust and abrasion particles of treated seeds as a parameter of the quality of treated seeds”. Treated seeds are introduced in the metal drum of the Heubach device, the drum is then reassembled and connected to the glass cylinder. A glass fiber filter disc is placed in the filter unit, the filter unit is then weighted and after placed on the glass cylinder and connected to the vacuum tube. The drum is put in rotation (30 rpm). The vacuum pump creates an air flow through the rotating drum, by the air flow the abraded dust particle are transported out of the rotating drum through the glass cylinder and the filter unit. At the end of the rotation, the filter unit is removed from the glass cylinder and weight. The Heubach dust value is expressed in g/100 kg of treated seeds and is calculated as the ratio of the weight difference of the filter unit after and before the test and the weight of treated seeds. The test is performed twice, the final results is the mean of the two measurements. The settings of the Heubach equipment are set as follows: rotation speed 60 rpm, rotation time 240 seconds, seed quantity 200 g and airflow rate 20 L/min. The dust measurements are performed on seeds treated with the different formulations. The results are summarized in Table 6.

TABLE 6

| | Dust level | Standard |
|---|---|---|
| Binder | (g/100 kg) | deviation |
| Control | 10.4 | 0.5 |
| SAL (Benchmark) - 20 mL/qt | 5.5 | 0.1 |
| SAL (Benchmark) - 70 mL/qt | 1.0 | 0.1 |
| Dispersion of rosin-based resin 2^{b)} 70 mL/qt | 1.2 | 0.1 |
| Dispersion of rosin-based resin 2 ^{b)} 35 mL/qt | 2.2 | 0.1 |
| Dispersion of rosin-based resin 1 ^{a)} 35 mL/qt | 4.0 | 0.2 |
| Dispersion of rosin-based resin 3 ^{c)} 35 mL/qt | 2.8 | 0.1 |

^{a)} Dispersion of rosin-based resin 1: dispersion of rosin acid with a % solids equals to 57% and a softening point to 75° C.
^{b)} Dispersion of rosin-based resin 2: dispersion of modified rosin ester with a % solids equals to 54% and a softening point to 45° C.
^{c)} Dispersion of rosin-based resin 3: dispersion of rosin ester with a % solids equals to 56% and a softening point to 76° C.

The 6 binders reduce the dust emission compared to the control. The 3 different dispersions of rosin-based resin trigger a significant reduction of dust emission compared to the formulation without binder, ranging from −61% to −88% of relative decrease. Comparable performances in terms of dust reduction are obtained the dispersion of rosin-based resin 2 at 70 mL/qt and for the benchmark at 70 mL/qt.

### Example 3

Biopolymer A is a biopolymer latex, more particularly an internally crosslinked starch (including amylose and amylopectin) particles having an average particle size in the range of 50 to 150 nm. The product is provided in the form of a dry powder of agglomerated nanoparticles with a volume mean diameter of about 300 microns

Binder formulations based on dispersion of Biopolymer A (starch particles) and dispersion of rosin-based resin were prepared as follows: starch particles are dispersed in demineralized water at a concentration equals to 35%, then dispersion of rosin-based resin is added to reach a final concentration in the formulation equals to 50% w/w. The different formulations of binder are detailed in Table 7.

TABLE 7

| | Formulation | Formulation |
|---|---|---|
| Component | F12 | F13 |
| Biopolymer A (starch particles) | 17.5% | 17.5% |
| Dispersion of rosin-based resin 4 | 50% | — |
| Dispersion of rosin-based resin 5 | — | 50% |
| Water | 32.5% | 32.5% |

In the Table 8 are presented the characteristics of the dispersion of rosin-based resin.

TABLE 8

| | Dispersion of rosin- | Dispersion of rosin- |
|---|---|---|
| Characteristics | based resin 4 | based resin 5 |
| Softening point (° C.) | 37 | 85 |
| % solids | 60 | 51 |

The viscosity of the binder formulation F12 and F13 were measured with a Brookfield apparatus LV at 20 rpm at 20° C. Measurements are presented in Table 9.

TABLE 9

| Formulation | Viscosity (cP) |
|---|---|
| Formulation F12 | 2140 |
| Formulation F13 | 10110 |

An acceptable viscosity (<3000 cP) is obtained for the binder formulation based on the rosin resin with the lower softening point (37° C.). For the other formulation based on a rosin resin with a high softening point (85° C.), a viscosity superior to 10 000 cP is measured, which is not acceptable for binder formulation.

Seed treatment formulation containing two fungicide slurries, water and binder formulations F12 or F13 are prepared by mixing all the components by magnetic agitation. A formulation without binder formulation is considered as the control. A commercial styrene acrylic latex dispersion (SAL) was utilized as a benchmark. Corn seeds of the variety C were treated with the different formulations with a laboratory seed coater Norogard R150 as follows: weight seeds and introduce them into the seed coater chamber, turn on seed coater (300 rpm), introduce seed treatment slurry, turn off seed coater (after 15 seconds of rotation) and discharge the treated seeds. The compositions of seed treatment formulations applied on seeds are detailed in Table 10.

TABLE 10

| | Formulation | Formulation | Formulation | Formulation |
|---|---|---|---|---|
| Component | 14 | 15 | 16 | 17 |
| Fungicide | 75 mL/qt | 75 mL/qt | 75 mL/qt | 75 mL/qt |
| slurry 1 | | | | |
| Fungicide | 250 mL/qt | 250 mL/qt | 250 mL/qt | 250 mL/qt |
| slurry 2 | | | | |
| Water | 690 mL/qt | 690 mL/qt | 690 mL/qt | 690 mL/qt |
| SAL | — | 20 mL/qt | — | — |
| (benchmark) | | | | |
| Formulation 12 | — | — | 20 mL/qt | — |
| Formulation 13 | — | — | — | 20 mL/qt |

Dust measurements were performed on the seeds treated with the four formulations with a Heubach dustmeter equipment according to Euroseeds reference method “Assessment of free floating dust and abrasion particles of treated seeds as a parameter of the quality of treated seeds”. Treated seeds are introduced in the metal drum of the Heubach device, the drum is then reassembled and connected to the glass cylinder. A glass fiber filter disc is placed in the filter unit, the filter unit is then weighted and after placed on the glass cylinder and connected to the vacuum tube. The drum is put in rotation (30 rpm). The vacuum pump creates an air flow through the rotating drum, by the air flow the abraded dust particle are transported out of the rotating drum through the glass cylinder and the filter unit. At the end of the rotation, the filter unit is removed from the glass cylinder and weight. The Heubach dust value is expressed in g/100 kg of treated seeds and is calculated as the ratio of the weight difference of the filter unit after and before the test and the weight of treated seeds. The test is performed twice, the final results is the mean of the two measurements. The settings of the Heubach equipment are set as follows: rotation speed 60 rpm, rotation time 240 seconds, seed quantity 200 g and airflow rate 20 L/min. The dust measurements are performed on seeds treated with the four formulations. The results are summarized in Table 11.

TABLE 11

| | Dust level | Standard |
|---|---|---|
| Binder | (g/100 kg) | deviation |
| Control | 10.6 | 0.1 |
| SAL (Benchmark) | 6.5 | 0.2 |
| Formulation F12 | 6.5 | 0.2 |
| Formulation F13 | 6.3 | 0.4 |

The two binder formulations F12 and F13 based on the dispersion of starch particles and the dispersion of rosin-based resin reduce the dust emission compared to the control seeds. Comparable performances in terms of dust reduction are obtained for the benchmark and the two binder formulations F12 and F13.

It is understood that embodiments other than those expressly described herein come within the spirit and scope of the present claims. Accordingly, the invention described herein is not defined by the above description, but is to be accorded the full scope of the claims so as to embrace any and all equivalent compositions and methods.

1-12. (canceled)

13. A coated seed composition comprising:
at least one seed; and
at least one layer coating all or part of the seed, the layer comprising at least one rosin-based resin.

14. The composition of claim 13, wherein the at least one rosin-based resin has a Ring and Ball softening point ranging from about 10° C. to about 150° C.

15. The composition of claim 13 comprising a dust value, as measured using a Heubach dustmeter device according to the Euroseeds reference method, which is lower by at least 30% as compared to an analogous binder-free composition that does not contain the rosin-based resin.

16. The composition of claim 13, wherein the rosin-based resin does not comprise polymers within the meaning of Article 3(5) of Regulation (EC) No 1907/2006.

17. The composition according to claim 13, further comprising a second binder.

18. The composition of claim 13 further comprising at least one active ingredient.

19. A method for preparing a coated seed composition having dust suppression benefits comprising the step of contacting at least a portion of at least one seed with at least one layer comprising at least one rosin-based resin,
wherein the coated seed composition comprises a dust value, as measured using a Heubach dustmeter device according to the Euroseeds reference method, which is lower by at least 30% as compared to an analogous binder-free composition that does not contain the rosin-based resin.

20. The method of claim 19, characterized by a dust value, as measured using a Heubach dustmeter device according to the Euroseeds reference method, which is lower by at least 50% as compared to an analogous binder-free composition that does not contain the rosin-based resin.

21. The method of claim 19, further comprising a second binder.

22. A method of providing dust suppression, the method comprising using at least one rosin-based resin as defined in claim 13 as a binder for a seed coating application.

23. A seed coating composition comprising at least one rosin-based resin as defined in claim 13.

24. The seed coating composition of claim 23, further comprising a second binder.
